(19) United States
(12) Patent Application Publication
(10) Pub. No.: US 2014/0336327 A1
(43) Pub. Date: Nov. 13, 2014

(54) POLYOLEFIN MASTERBATCH BASED ON GRAFTED POLYPROPYLENE AND METALLOCENE CATALYZED POLYPROPYLENE

(71) Applicants: Maged G. Botros, Liberty Township, OH (US); Thomas Mecklenburg, Butzbach (DE)

(72) Inventors: Maged G. Botros, Liberty Township, OH (US); Thomas Mecklenburg, Butzbach (DE)

(73) Assignees: Equistar Chemicals, LP, Houston, TX (US); Basell Polyolefine GmbH, Wesseling (DE)

(21) Appl. No.: 14/273,047

(22) Filed: May 8, 2014

Related U.S. Application Data
(60) Provisional application No. 61/820,948, filed on May 8, 2013.

(51) Int. Cl. C08L 51/06

(52) U.S. Cl. CPC C08L 51/06; C08L 2310/00; C08L 2314/02; C08L 2314/06; C08L 2205/025
USPC 524/504; 525/74

(57) ABSTRACT

The present disclosure provides masterbatch compositions comprising a polypropylene grafted with a grafting monomer selected from maleic anhydride, acrylic acid or other acid or anhydride functional groups that could be grafted to a polypropylene backbone and a metallocene catalyzed polypropylene base resin. Additionally, the present disclosure provides a polymer composition which includes from 0.1 to 10.0 wt. % of the masterbatch composition, and from 50 to 90% of a third polypropylene, and from 5 to 45% of a filler.

### CROSS-REFERENCES TO RELATED APPLICATIONS

This application claims the benefit of U.S. Provisional Application No. 61/820,948, filed May 8, 2013, the contents of which are incorporated herein by reference in its entirety.

### TECHNICAL FIELD

In general, the present disclosure relates to the field of polymer chemistry. In particular, the present disclosure relates to polyolefins, polypropylene, and grafted polypropylene. More particularly, the present disclosure relates to masterbatch compositions made of a grafted impact propylene copolymer and a metallocene derived polypropylene.

### BACKGROUND OF THE INVENTION

The development of polymer blends, composites and laminates is a very active area of science and technology; of great economic importance not only for the plastics industry but also for many other industries where the use of such products is becoming increasingly more common.

Most pairs of polymers are immiscible with each other. Even worse is the fact that they also have less compatibility than would be required in order to obtain the desired level of properties and performance from their blends. Compatibilizers are often used as additives to improve the compatibility of immiscible polymers and thus improve the morphology and resulting properties of the blend. Similarly, it is often challenging to disperse fillers effectively in the matrix polymer of a composite, or to adhere layers of polymers to each other or to other substrates (such as glass or metals) in laminates.

Accordingly, the compatibilization of immiscible polymers is one of the most important, widespread and difficult problems in contemporary applied polymer science. In investigating various methods of compatibilizing immiscible blends, one can roughly distinguish two broad types of approaches: (1) modification of processing conditions which may include (a) increasing the processing temperature, and (b) increasing the motor speed and/or improving the mixing by some other means; and, (2) modification of polymer formulation by incorporating additives such as (a) “standard” (premade) compatibilizers, (b) reactive compatibilizers, and/or (c) other substances (such as silica, carbon, or clay nanoparticles) that may manifest a compatibilizing effect under some conditions.

It is difficult to prescribe a priori which method should be used for any particular problem. Each method has its own advantages and disadvantages. For example, if it were practically feasible, increasing the processing temperature to the point where two polymers become miscible would certainly solve thermodynamic incompatibility problems. However, this solution is impractical for many realistic systems in which the transition from a two-phase system to a one-phase system occurs far above the decomposition temperature of one or both components.

Improving mixing can be relatively easy and straightforward, but the mixture can quickly phase separate into large droplets once shear (a kinetic factor) is removed.

Compatibilizers (such as short chains of block copolymers or random copolymers) can reduce the interfacial tension to near-zero levels and promote mixing on the nanoscale. However, this effect is limited by the migration kinetics of compatibilizer molecules towards interfaces and can thus be very slow.

Reactive compatibilizers rely on chemical reactions that take place during processing to attach themselves to the polymers that are being blended and thus compatibilize immiscible polymers with each other. In practice, they can be either more effective or less effective than standard compatibilizers, depending on the choices of reactive groups and catalysts.

The addition of lower molecular weight molecules (compatibilizers) sometimes leads to a dramatic worsening of various properties (such as stiffness, toughness, or flame retardancy) even if these additives improve the compatibility of the polymers in the blend.

The addition of nanoparticles may be a useful and interesting method of compatibilization, but its mechanism is not well-understood and so far there have been only a few studies describing this effect which is at the frontiers of compatibilization science and technology.

These problems must be balanced against the fact that many additives can often perform multiple roles and sometimes do so simultaneously in a given polymeric system. For example, a “blend compatibilizer” may also functions as an “impact modifier”. The morphological changes resulting from enhanced compatibility can, in some cases, increase the impact strength at ambient temperature and help retain acceptable impact strength at lower temperatures than is possible in the absence of the additive. These morphological changes typically are the development of much smaller (in some instances, interpenetrating) phase domains that are better connected to each other, enabling improved load transfer across phase boundaries.

If a polymer (or blend) contains reinforcing fillers (such as inorganic fibers), an additive that can compatibilize the polymers in a blend may also act as a “coupling agent” between the polymer(s) and inorganic fillers, helping disperse the fillers and bond them to the polymer(s) and thus increase the stiffness (modulus), strength and impact toughness of the composite. In another example, a compatibilizer may often also act as an “adhesion promoter” between a polymer (or blend) and a substrate, or between adjacent layers consisting of dissimilar polymers in a multilayer structure.

Therefore, there is a need to develop masterbatch compositions that have broad utility. In particular there is a need to develop masterbatch compositions that function as both a compatibilizer and a coupling agent.

The use of masterbatches are known to be a preferred way to incorporate resin into polypropylene formulations. An advantage of using a masterbatch composition is that it can be added to many and different kinds of polyolefins to achieve a final polyolefin composition ready for production, by injection molding, of large articles such as automobile bumpers. Thus there is a constant need for masterbatch compositions able to produce, by blending with various polyolefin materials, final compositions exhibiting a good balance of physical and surface properties.

### BRIEF SUMMARY OF THE INVENTION

In general, the present disclosure provides a polymer composition comprising a masterbatch composition, a polypropylene and a filler. In particular, the polymer composition comprises 0.1 to 10 wt. % (based on total weight of the polymer composition) of a masterbatch composition, 50 to 90 wt. % (based on total weight of the polymer composition) of a polypropylene and 5 to 45 wt. % (based on total weight of the polymer composition) of a filler. In general, the masterbatch composition acts as either a coupling agent or a compatibilizer.

In general embodiments, the present disclosure provides a polymer composition comprising: from 0.1 to 10.0 wt. % (based on total weight of the polymer composition) of a masterbatch composition; from 50 to 90 wt. % (based on total weight of the polymer composition) of a third polypropylene; and from 5 to 45 wt. % (based on total weight of the polymer composition) of a filler. The masterbatch composition comprises: (1) from 1 to 99 wt. % (based on total weight of the masterbatch composition) of a first polypropylene composition, wherein the first polypropylene composition comprises a polypropylene grafted with a monomer containing acid or anhydride functional groups, and (2) from 1 to 99 wt. % (based on total weight of the masterbatch composition) of a second polypropylene obtained by using a metallocene catalyst.

In some embodiments, the acid or anhydride functional group is maleic anhydride. In further embodiments, the maleic anhydride is 0.5-5 wt. % (based on total weight of the grafted polypropylene) of the grafted polypropylene. In some embodiments, the filler is short glass fibers, talc, mica, nanoclays, fire retardants, and foaming agents, or mixtures thereof.

In some embodiments, the first polypropylene is an impact modified heterophasic polypropylene copolymer. In some embodiments, the second polypropylene is a homopolymer. In some embodiments, the third polypropylene is obtained by using a Ziegler-Natta catalyst.

In further embodiments, the second polypropylene has a melt flow rate (measured at 230° C./2.16 kg) of at least 100 g/10 min. In specific embodiments, the second polypropylene has a melt flow rate (measured at 230° C./2.16 kg) of at least 450 g/10 min.

In some embodiments, the polymer composition further comprises an additive. In certain embodiments, the additive is a stabilizer, antioxidant, neutralizing agent, organic or inorganic pigment, antistatic agent, nonpolar wax, or low molecular weight glidant, low molecular weight lubricant, or mixtures thereof.

In general embodiments, the masterbatch composition comprises: (1) from 50 to 99 wt % (based on total weight of the masterbatch composition) of a first polypropylene composition, wherein the first polypropylene composition comprises a polypropylene grafted with a monomer containing acid or anhydride functional groups, and (2) from 1 to 50 wt % (based on total weight of the masterbatch composition) of a second polypropylene obtained by using a metallocene catalyst. In additional embodiments, the acid or anhydride functional group is maleic anhydride. In specific embodiments, the maleic anhydride is 0.5-5 wt. % of the grafted polypropylene.

In some embodiments, the masterbatch composition comprises a first polypropylene that is an impact heterophasic polypropylene copolymer. In additional embodiments, the masterbatch composition comprises a second polypropylene that is a homopolymer.

In certain embodiments, the present disclosure provides a masterbatch composition comprising: (1) from 1 to 99 wt (based on total weight of the masterbatch composition) of a first polypropylene composition wherein the first polypropylene comprises a polypropylene grafted with a monomer containing maleic anhydride functional groups and (2) from 1 to 99 wt % (based on total weight of the masterbatch composition) of a second polypropylene obtained by using a metallocene catalyst having Melt Flow Rate (230° C./2.16 kg) higher than 100 g/10 min.

In particular embodiments, the masterbatch composition contains a first polypropylene that is an impact heterophasic polypropylene copolymer. In further embodiments, the masterbatch composition comprises a second polypropylene that is a homopolymer.

In specific embodiments, the present disclosure provides a compatibilizer comprising a masterbatch composition that further comprises: (1) from 50 to 99 wt (based on total weight of the masterbatch composition) of a first polypropylene composition, wherein the first polypropylene composition comprises a polypropylene grafted with a monomer containing acid or anhydride functional groups, and (2) from 1 to 50 wt % (based on total weight of the masterbatch composition) of a second polypropylene obtained by using a metallocene catalyst. When the masterbatch composition functions as compatibilizer, there is no covalent bond formed between the acid functional group and/or the anhydride functional group of the grafted polypropylene and the filler.

In specific embodiments, the present disclosure provides a coupling agent comprising a masterbatch composition comprising: (1) from 50 to 99 wt (based on total weight of the masterbatch composition) of a first polypropylene composition, wherein the first polypropylene composition comprises a polypropylene grafted with a monomer containing acid or anhydride functional groups, and (2) from 1 to 50 wt (based on total weight of the masterbatch composition) of a second polypropylene obtained by using a metallocene catalyst. When the masterbatch composition functions as coupling agent there is a covalent bond formed between the acid functional group and/or anhydride functional group of the grafted polypropylene and the filler.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### DETAILED DESCRIPTION OF THE INVENTION

The present disclosure provides masterbatch compositions comprising: (1) a polypropylene grafted with a grafting monomer selected from maleic anhydride, acrylic acid or any other acid or anhydride functional groups that could be grafted to a polypropylene backbone; and, (2) a metallocene catalyzed polypropylene base resin. The masterbatch compositions may be used in glass fiber filled polypropylene composite applications. In some examples, the masterbatch composition may be used to replace Ziegler-Natta based coupling agents that are typically included in glass fiber filled polypropylene composite applications. The masterbatch compositions have utility as a compatibilizer or as a coupling agent. As a compatibilizer, the masterbatch compositions could be added in polymer alloys to enhance the compatibility between dissimilar polymers, such as blends comprising a polyolefin and a polyamide. Polypropylene composite with fillers such as glass, nanoclays, mica, talc, fire retardants, foaming agents, and the like will also benefit from the masterbatch composition as disclosed herein. In some embodiments, the filler is a glass filler. In particular, the glass filler is a glass fiber, a glass fiber having chopped strands and/or a functionalized glass fiber.

In general embodiments, the present disclosure provides a masterbatch composition comprising 50 to about 99 weight percent (wt. % is based on total weight of the masterbatch composition) of a first polypropylene grafted with a monomer containing acid or anhydride functional groups, and from 1 to 50 wt. % (based on total weight of the masterbatch composition) of a second polypropylene obtained by using a metallocene catalyst.

In particular embodiments, the masterbatch composition comprises 55 to about 99 weight percent (wt. % is based on total weight of the masterbatch composition) of a first polypropylene grafted with a monomer containing acid or anhydride functional groups, and from 1 to 45 wt. % (based on total weight of the masterbatch composition) of a second polypropylene obtained by using a metallocene catalyst. The masterbatch composition may comprise 60 to about 99 weight percent (wt. % is based on total weight of the masterbatch composition) of a first polypropylene grafted with a monomer containing acid or anhydride functional groups, and from 1 to 40 wt. % (based on total weight of the masterbatch composition) of a second polypropylene obtained by using a metallocene catalyst. The masterbatch composition may comprise 70 to about 99 weight percent (wt. % is based on total weight of the masterbatch composition) of a first polypropylene grafted with a monomer containing acid or anhydride functional groups, and from 1 to 30 wt. % (based on total weight of the masterbatch composition) of a second polypropylene obtained by using a metallocene catalyst. The masterbatch composition may comprise 80 to about 99 weight percent (wt. % is based on total weight of the masterbatch composition) of a first polypropylene grafted with a monomer containing acid or anhydride functional groups, and from 1 to 20 wt. % (based on total weight of the masterbatch composition) of a second polypropylene obtained by using a metallocene catalyst. The masterbatch composition may comprise 90 to about 99 weight percent (wt. % is based on total weight of the masterbatch composition) of a first polypropylene grafted with a monomer containing acid or anhydride functional groups, and from 1 to 10 wt. % (based on total weight of the masterbatch composition) of a second polypropylene obtained by using a metallocene catalyst. The masterbatch composition may comprise 50 to about 90 weight percent (wt. % is based on total weight of the masterbatch composition) of a first polypropylene grafted with a monomer containing acid or anhydride functional groups, and from 10 to 50 wt. % (based on total weight of the masterbatch composition) of a second polypropylene obtained by using a metallocene catalyst. The masterbatch composition may comprise 50 to about 80 weight percent (wt. % is based on total weight of the masterbatch composition) of a first polypropylene grafted with a monomer containing acid or anhydride functional groups, and from 20 to 50 wt. % (based on total weight of the masterbatch composition) of a second polypropylene obtained by using a metallocene catalyst. The masterbatch composition may comprise 50 to about 70 weight percent (wt. % is based on total weight of the masterbatch composition) of a first polypropylene grafted with a monomer containing acid or anhydride functional groups, and from 30 to 50 wt. % (based on total weight of the masterbatch composition) of a second polypropylene obtained by using a metallocene catalyst. The masterbatch composition may comprise 50 to about 60 weight percent (wt. % is based on total weight of the masterbatch composition) of a first polypropylene grafted with a monomer containing acid or anhydride functional groups, and from 40 to 50 wt. % (based on total weight of the masterbatch composition) of a second polypropylene obtained by using a metallocene catalyst.

In some embodiments, the present disclosure provides a masterbatch composition which comprises from 1 to 99 wt. % (based on total weight of the masterbatch composition) of a first polypropylene grafted with a monomer containing maleic anhydride functional groups and from 1 to 99 wt. % (based on total weight of the masterbatch composition) of a second polypropylene obtained by using a metallocene catalyst having melt flow rate (230° C./2.16 kg) higher than 100 g/10 min.

In particular embodiments, a masterbatch composition may include from 10 to 99 wt. % (based on total weight of the masterbatch composition) of a first polypropylene grafted with a monomer containing maleic anhydride functional groups and from 1 to 90 wt. % (based on total weight of the masterbatch composition) of a second polypropylene obtained by using a metallocene catalyst having melt flow rate (230° C./2.16 kg) higher than 100 g/10 min. A masterbatch composition may include from 20 to 99 wt. % (based on total weight of the masterbatch composition) of a first polypropylene grafted with a monomer containing maleic anhydride functional groups and from 1 to 80 wt. % (based on total weight of the masterbatch composition) of a second polypropylene obtained by using a metallocene catalyst having melt flow rate (230° C./2.16 kg) higher than 100 g/10 min. A masterbatch composition may include from 30 to 99 wt. % (based on total weight of the masterbatch composition) of a first polypropylene grafted with a monomer containing maleic anhydride functional groups and from 1 to 70 wt. % (based on total weight of the masterbatch composition) of a second polypropylene obtained by using a metallocene catalyst having melt flow rate (230° C./2.16 kg) higher than 100 g/10 min. A masterbatch composition may include from 40 to 99 wt. % (based on total weight of the masterbatch composition) of a first polypropylene grafted with a monomer containing maleic anhydride functional groups and from 1 to 60 wt. % (based on total weight of the masterbatch composition) of a second polypropylene obtained by using a metallocene catalyst having melt flow rate (230° C./2.16 kg) higher than 100 g/10 min. A masterbatch composition may include from 50 to 99 wt. % (based on total weight of the masterbatch composition) of a first polypropylene grafted with a monomer containing maleic anhydride functional groups and from 1 to 50 wt. % (based on total weight of the masterbatch composition) of a second polypropylene obtained by using a metallocene catalyst having melt flow rate (230° C./2.16 kg) higher than 100 g/10 min. A masterbatch composition may include from 60 to 99 wt. % (based on total weight of the masterbatch composition) of a first polypropylene grafted with a monomer containing maleic anhydride functional groups and from 1 to 40 wt. % (based on total weight of the masterbatch composition) of a second polypropylene obtained by using a metallocene catalyst having melt flow rate (230° C./2.16 kg) higher than 100 g/10 min. A masterbatch composition may include from 70 to 99 wt. % (based on total weight of the masterbatch composition) of a first polypropylene grafted with a monomer containing maleic anhydride functional groups and from 1 to 30 wt. % (based on total weight of the masterbatch composition) of a second polypropylene obtained by using a metallocene catalyst having melt flow rate (230° C./2.16 kg) higher than 100 g/10 min. A masterbatch composition may include from 80 to 99 wt. % (based on total weight of the masterbatch composition) of a first polypropylene grafted with a monomer containing maleic anhydride functional groups and from 1 to 20 wt. % (based on total weight of the masterbatch composition) of a second polypropylene obtained by using a metallocene catalyst having melt flow rate (230° C./2.16 kg) higher than 100 g/10 min. A masterbatch composition may include from 90 to 99 wt. % (based on total weight of the masterbatch composition) of a first polypropylene grafted with a monomer containing maleic anhydride functional groups and from 1 to 10 wt. % (based on total weight of the masterbatch composition) of a second polypropylene obtained by using a metallocene catalyst having melt flow rate (230° C./2.16 kg) higher than 100 g/10 min. A masterbatch composition may include from 1 to 90 wt. % (based on total weight of the masterbatch composition) of a first polypropylene grafted with a monomer containing maleic anhydride functional groups and from 10 to 99 wt. % (based on total weight of the masterbatch composition) of a second polypropylene obtained by using a metallocene catalyst having melt flow rate (230° C./2.16 kg) higher than 100 g/10 min. A masterbatch composition may include from 1 to 80 wt. % (based on total weight of the masterbatch composition) of a first polypropylene grafted with a monomer containing maleic anhydride functional groups and from 20 to 99 wt. % (based on total weight of the masterbatch composition) of a second polypropylene obtained by using a metallocene catalyst having melt flow rate (230° C./2.16 kg) higher than 100 g/10 min. A masterbatch composition may include from 1 to 70 wt. % (based on total weight of the masterbatch composition) of a first polypropylene grafted with a monomer containing maleic anhydride functional groups and from 30 to 99 wt. % (based on total weight of the masterbatch composition) of a second polypropylene obtained by using a metallocene catalyst having melt flow rate (230° C./2.16 kg) higher than 100 g/10 min. A masterbatch composition may include from 1 to 60 wt. % (based on total weight of the masterbatch composition) of a first polypropylene grafted with a monomer containing maleic anhydride functional groups and from 40 to 99 wt. % (based on total weight of the masterbatch composition) of a second polypropylene obtained by using a metallocene catalyst having melt flow rate (230° C./2.16 kg) higher than 100 g/10 min. A masterbatch composition may include from 1 to 50 wt. % (based on total weight of the masterbatch composition) of a first polypropylene grafted with a monomer containing maleic anhydride functional groups and from 50 to 99 wt. % (based on total weight of the masterbatch composition) of a second polypropylene obtained by using a metallocene catalyst having melt flow rate (230° C./2.16 kg) higher than 100 g/10 min. A masterbatch composition may include from 1 to 40 wt. % (based on total weight of the masterbatch composition) of a first polypropylene grafted with a monomer containing maleic anhydride functional groups and from 60 to 99 wt. % (based on total weight of the masterbatch composition) of a second polypropylene obtained by using a metallocene catalyst having melt flow rate (230° C./2.16 kg) higher than 100 g/10 min. A masterbatch composition may include from 1 to 30 wt. % (based on total weight of the masterbatch composition) of a first polypropylene grafted with a monomer containing maleic anhydride functional groups and from 70 to 99 wt. % (based on total weight of the masterbatch composition) of a second polypropylene obtained by using a metallocene catalyst having melt flow rate (230° C./2.16 kg) higher than 100 g/10 min. A masterbatch composition may include from 1 to 20 wt. % (based on total weight of the masterbatch composition) of a first polypropylene grafted with a monomer containing maleic anhydride functional groups and from 80 to 99 wt. % (based on total weight of the masterbatch composition) of a second polypropylene obtained by using a metallocene catalyst having melt flow rate (230° C./2.16 kg) higher than 100 g/10 min. A masterbatch composition may include from 1 to 10 wt. % (based on total weight of the masterbatch composition) of a first polypropylene grafted with a monomer containing maleic anhydride functional groups and from 90 to 99 wt. % (based on total weight of the masterbatch composition) of a second polypropylene obtained by using a metallocene catalyst having melt flow rate (230° C./2.16 kg) higher than 100 g/10 min.

In general, the masterbatch composition may contain additives. In some embodiments, the masterbatch composition comprises at least one second polypropylene. In some embodiments, the second polypropylene composition comprises more than one polypropylene. When more than one polypropylene is present in the second polypropylene composition, at least one polypropylene is derived from a metallocene.

The masterbatch composition may include 50 to about 99 weight percent (wt. % is based on total weight of the masterbatch composition) of a first polypropylene grafted with a monomer containing acid or anhydride functional groups, from 1 to 50 wt. % (based on total weight of the masterbatch composition) of a second polypropylene composition, and from 0.001 to 2.0 wt. % (based on total weight of the masterbatch composition) of an additive, wherein the monomer incorporated into the grafted first polypropylene is present in a range from 0.02 to 3.5 wt. % (based on total weight of the masterbatch composition). In specific embodiments, the masterbatch composition may include about 50 weight percent (wt. % is based on total weight of the masterbatch composition) of a first polypropylene grafted with a monomer containing acid or anhydride functional groups, about 49.85 wt. % (based on total weight of the masterbatch composition) of a second polypropylene composition, and from 0.001 to 2.0 wt. % (based on total weight of the masterbatch composition) of an additive, wherein the monomer incorporated into the grafted first polypropylene is present in a range from 0.02 to 3.5 wt. % (based on total weight of the masterbatch composition). The masterbatch composition may include about 60 weight percent (wt. % is based on total weight of the masterbatch composition) of a first polypropylene grafted with a monomer containing acid or anhydride functional groups, about 39.85 wt. % (based on total weight of the masterbatch composition) of a second polypropylene composition, and from 0.001 to 2.0 wt. % (based on total weight of the masterbatch composition) of an additive, wherein the monomer incorporated into the grafted first polypropylene is present in a range from 0.02 to 3.5 wt. % (based on total weight of the masterbatch composition). The masterbatch composition may include about 70 weight percent (wt. % is based on total weight of the masterbatch composition) of a first polypropylene grafted with a monomer containing acid or anhydride functional groups, about 29.85 wt. % (based on total weight of the masterbatch composition) of a second polypropylene composition, and from 0.001 to 2.0 wt. % (based on total weight of the masterbatch composition) of an additive, wherein the monomer incorporated into the grafted first polypropylene is present in a range from 0.02 to 3.5 wt. % (based on total weight of the masterbatch composition). The masterbatch composition may include about 80 weight percent (wt. % is based on total weight of the masterbatch composition) of a first polypropylene grafted with a monomer containing acid or anhydride functional groups, about 19.85 wt. % (based on total weight of the masterbatch composition) of a second polypropylene composition, and from 0.001 to 2.0 wt. % (based on total weight of the masterbatch composition) of an additive, wherein the monomer incorporated into the grafted first polypropylene is present in a range from 0.02 to 3.5 wt. % (based on total weight of the masterbatch composition). The masterbatch composition may include about 90 weight percent (wt. % is based on total weight of the masterbatch composition) of a first polypropylene grafted with a monomer containing acid or anhydride functional groups, about 9.85 wt. % (based on total weight of the masterbatch composition) of a second polypropylene composition, and from 0.001 to 2.0 wt. % (based on total weight of the masterbatch composition) of an additive, wherein the monomer incorporated into the grafted first polypropylene is present in a range from 0.02 to 3.5 wt. % (based on total weight of the masterbatch composition). The masterbatch composition may include about 95 weight percent (wt. % is based on total weight of the masterbatch composition) of a first polypropylene grafted with a monomer containing acid or anhydride functional groups, about 4.85 wt. % (based on total weight of the masterbatch composition) of a second polypropylene composition, and from 0.001 to 2.0 wt. % (based on total weight of the masterbatch composition) of an additive, wherein the monomer incorporated into the grafted first polypropylene is present in a range from 0.02 to 3.5 wt. % (based on total weight of the masterbatch composition).

The masterbatch composition may include about 50 weight percent (wt. % is based on total weight of the masterbatch composition) of a first polypropylene grafted with a monomer containing acid or anhydride functional groups, about 49.85 wt. % (based on total weight of the masterbatch composition) of a second polypropylene composition, and about 0.15 wt. % (based on total weight of the masterbatch composition) of an additive(s), wherein the monomer incorporated into the grafted first polypropylene is present in a range from 0.02 to 3.5 wt. % (based on total weight of the masterbatch composition). The masterbatch composition may include about 60 weight percent (wt. % is based on total weight of the masterbatch composition) of a first polypropylene grafted with a monomer containing acid or anhydride functional groups, about 39.85 wt. % (based on total weight of the masterbatch composition) of a second polypropylene composition, and about 0.15 wt. % (based on total weight of the masterbatch composition) of an additive(s), wherein the monomer incorporated into the grafted first polypropylene is present in a range from 0.02 to 3.5 wt. % (based on total weight of the masterbatch composition). The masterbatch composition may include about 70 weight percent (wt. % is based on total weight of the masterbatch composition) of a first polypropylene grafted with a monomer containing acid or anhydride functional groups, about 29.85 wt. % (based on total weight of the masterbatch composition) of a second polypropylene composition, and about 0.15 wt. % (based on total weight of the masterbatch composition) of an additive(s), wherein the monomer incorporated into the grafted first polypropylene is present in a range from 0.02 to 3.5 wt. % (based on total weight of the masterbatch composition). The masterbatch composition may include about 80 weight percent (wt. % is based on total weight of the masterbatch composition) of a first polypropylene grafted with a monomer containing acid or anhydride functional groups, about 19.85 wt. % (based on total weight of the masterbatch composition) of a second polypropylene composition, and about 0.15 wt. % (based on total weight of the masterbatch composition) of an additive(s), wherein the monomer incorporated into the grafted first polypropylene is present in a range from 0.02 to 3.5 wt. % (based on total weight of the masterbatch composition). The masterbatch composition may include about 90 weight percent (wt. % is based on total weight of the masterbatch composition) of a first polypropylene grafted with a monomer containing acid or anhydride functional groups, about 9.85 wt. % (based on total weight of the masterbatch composition) of a second polypropylene composition, and about 0.15 wt. % (based on total weight of the masterbatch composition) of an additive(s), wherein the monomer incorporated into the grafted first polypropylene is present in a range from 0.02 to 3.5 wt. % (based on total weight of the masterbatch composition).

In general embodiments, a polymer composition may include from 0.1 to 5.0 wt. % (based on total weight of the polymer composition) of a masterbatch composition, from 50 to 90 wt. % (based on total weight of the polymer composition) of a third polypropylene, and from 5 to 45 wt. % (based on total weight of the polymer composition) of a filler.

In some embodiments, a polymer composition may include from 0.1 to 4.0 wt. % (based on total weight of the polymer composition) of a masterbatch composition, from 50 to 90 wt. % (based on total weight of the polymer composition) of a third polypropylene, and from 5 to 46 wt. % (based on total weight of the polymer composition) of a filler. A polymer composition may include from 0.1 to 3.0 wt. % (based on total weight of the polymer composition) of a masterbatch composition, from 50 to 90 wt. % (based on total weight of the polymer composition) of a third polypropylene, and from 5 to 47 wt. % (based on total weight of the polymer composition) of a filler. A polymer composition may include from 0.1 to 2.0 wt. % (based on total weight of the polymer composition) of a masterbatch composition, from 50 to 90 wt. % (based on total weight of the polymer composition) of a third polypropylene, and from 5 to 48 wt. % (based on total weight of the polymer composition) of a filler. A polymer composition may include from 0.1 to 1.0 wt. % (based on total weight of the polymer composition) of a masterbatch composition, from 50 to 90 wt. % (based on total weight of the polymer composition) of a third polypropylene, and from 5 to 49 wt. % (based on total weight of the polymer composition) of a filler.

In additional embodiments, a polymer composition may include from 0.1 to 4.0 wt. % (based on total weight of the polymer composition) of a masterbatch composition, from 51 to 90 wt. % (based on total weight of the polymer composition) of a third polypropylene, and from 5 to 45 wt. % (based on total weight of the polymer composition) of a filler. A polymer composition may include from 0.1 to 3.0 wt. % (based on total weight of the polymer composition) of a masterbatch composition, from 52 to 90 wt. % (based on total weight of the polymer composition) of a third polypropylene, and from 5 to 45 wt. % (based on total weight of the polymer composition) of a filler. A polymer composition may include from 0.1 to 2.0 wt. % (based on total weight of the polymer composition) of a masterbatch composition, from 53 to 90 wt. % (based on total weight of the polymer composition) of a third polypropylene, and from 5 to 45 wt. % (based on total weight of the polymer composition) of a filler. A polymer composition may include from 0.1 to 1.0 wt. % (based on total weight of the polymer composition) of a masterbatch composition, from 54 to 90 wt. % (based on total weight of the polymer composition) of a third polypropylene, and from 5 to 45 wt. % (based on total weight of the polymer composition) of a filler.

In further embodiments, a polymer composition may include from 0.1 to 5.0 wt. % (based on total weight of the polymer composition) of a masterbatch composition, from 50 to 80 wt. % (based on total weight of the polymer composition) of a third polypropylene, and from 15 to 45 wt. % (based on total weight of the polymer composition) of a filler. A polymer composition may include from 0.1 to 5.0 wt. % (based on total weight of the polymer composition) of a masterbatch composition, from 50 to 70 wt. % (based on total weight of the polymer composition) of a third polypropylene, and from 25 to 45 wt. % (based on total weight of the polymer composition) of a filler. A polymer composition may include from 0.1 to 5.0 wt. % (based on total weight of the polymer composition) of a masterbatch composition, from 50 to 60 wt. % (based on total weight of the polymer composition) of a third polypropylene, and from 35 to 45 wt. % (based on total weight of the polymer composition) of a filler.

In specific embodiments, a polymer composition may include 2.5 wt. % (based on total weight of the polymer composition) of a masterbatch composition, 65 wt. % (based on total weight of the polymer composition) of a third polypropylene, 30 wt. % (based on total weight of the polymer composition) of a filler, and 2.5 wt (based on total weight of the polymer composition) of other additives. A polymer composition may include 1.5 wt. % (based on total weight of the polymer composition) of a masterbatch composition, 65 wt. % (based on total weight of the polymer composition) of a third polypropylene, 30 wt. % (based on total weight of the polymer composition) of a filler, and 3.5 wt (based on total weight of the polymer composition) of other additives. A polymer composition may include 0.5 wt. % (based on total weight of the polymer composition) of a masterbatch composition, 65 wt. % (based on total weight of the polymer composition) of a third polypropylene, 30 wt. % (based on total weight of the polymer composition) of a filler, and 4.5 wt (based on total weight of the polymer composition) of other additives. A polymer composition may include 2.5 wt. % (based on total weight of the polymer composition) of a masterbatch composition, 55 wt. % (based on total weight of the polymer composition) of a third polypropylene, 40 wt. % (based on total weight of the polymer composition) of a filler, and 2.5 wt (based on total weight of the polymer composition) of other additives. A polymer composition may include 2.5 wt. % (based on total weight of the polymer composition) of a masterbatch composition, 50 wt. % (based on total weight of the polymer composition) of a third polypropylene, 45 wt. % (based on total weight of the polymer composition) of a filler, and 2.5 wt (based on total weight of the polymer composition) of other additives. A polymer composition may include 2.5 wt. % (based on total weight of the polymer composition) of a masterbatch composition, 75 wt. % (based on total weight of the polymer composition) of a third polypropylene, 20 wt. % (based on total weight of the polymer composition) of a filler, and 2.5 wt (based on total weight of the polymer composition) of other additives. A polymer composition may include 2.5 wt. % (based on total weight of the polymer composition) of a masterbatch composition, 85 wt. % (based on total weight of the polymer composition) of a third polypropylene, 10 wt. % (based on total weight of the polymer composition) of a filler, and 2.5 wt (based on total weight of the polymer composition) of other additives. A polymer composition may include 2.5 wt. % (based on total weight of the polymer composition) of a masterbatch composition, 90 wt. % (based on total weight of the polymer composition) of a third polypropylene, 5 wt. % (based on total weight of the polymer composition) of a filler, and 2.5 wt (based on total weight of the polymer composition) of other additives.

In specific embodiments, the present disclosure provides a polymer composition comprising from 0.1 to 5.0 wt. % (based on total weight of the polymer composition) of a masterbatch composition which comprises from 1 to 99 wt. % (based on total weight of the masterbatch composition) of a first polypropylene grafted with a monomer containing acid or anhydride functional groups, and from 1 to 99 wt. % (based on total weight of the masterbatch composition) of a second polypropylene obtained by using a metallocene catalyst, from 50 to 90 wt. % (based on total weight of the polymer composition) of a third polypropylene, and from 5 to 45 wt. % (based on total weight of the polymer composition) of a filler.

In additional embodiments, the present disclosure provides a polymer composition comprising: (A) from 0.1 to 5.0 wt. % (based on total weight of the polymer composition) of a masterbatch composition which comprises from 1 to 99 wt. % (based on total weight of the masterbatch composition) of a first polypropylene grafted with a monomer containing acid or anhydride functional groups, and from 1 to 99 wt. % (based on total weight of the masterbatch composition) of a second polypropylene obtained by using a metallocene catalyst, (B) from 50 to 90 wt. % (based on total weight of the polymer composition) of a third polypropylene, (C) from 5 to 45 wt. % (based on total weight of the polymer composition) of a filler; and, (D) from 0.001 to 5.0 wt. % (based on total weight of the polymer composition) of an additive.

The grafted polypropylene may be grafted with an acid or an anhydride. For example, the grafted polypropylene may be grafted with a monomeric unit including, but not limited to, acrylic acid and maleic anhydride. Other acid and anhydrides may be used to form the grafted polypropylene as long as the monomeric unit is capable of being incorporated into the polymerized propylene by a free radical coupling process. One or more of these monomers can be used in the various embodiments of compositions disclosed herein.

The grafted polypropylene may contain acid or anhydride functional groups in a range from about 0.5 wt. % to about 3.5 wt. % of the grafted polypropylene. Preferably, the amount of acid or anhydride functional groups present in the grafted polypropylene ranges from from about 1 wt. % to about 3 wt. % of the grafted polypropylene. More preferably, the amount of acid or anhydride functional groups present in the grafted polypropylene ranges from about 1 wt. % to about 2 wt. % of the grafted polypropylene. Even more preferably, the amount of acid or anhydride functional groups present in the grafted polypropylene is about 2 wt. % of the grafted polypropylene.

Particularly preferred polymers are polypropylene, such as a propylene homopolymer or a propylene copolymer having up to 30% by weight of other olefins up to 10 carbon atoms in copolymerized form. Such other olefins are in particular C₂ to C₁₀-1-alkenes, such as ethylene, 1-butene, 1-pentene, 1-hexene, 1-heptene or 1-octene, with preference for ethylene, 1-butene or ethylene and 1-butene. Particular preference is for propylene homopolymers.

If a propylene copolymer is used, impact modified heterophasic polypropylene copolymers are preferred. Copolymers of propylene which have an impact modification are polymers in which, in a first stage are a propylene homopolymer or a random copolymer of propylene having up to 15% by weight, preferably up to 6% by weight, and more preferably up to 2% by weight, of other olefins having up to 10 carbon atoms as comonomers, and then, in a second stage, a propylene-ethylene copolymer having ethylene contents of from 15 to 99% by weight, the propylene-ethylene copolymer additionally being able to contain further C4-C10 olefins, is polymerized thereto. In general, sufficient propylene-ethylene copolymer is polymerized thereto that the copolymer generated in the second stage has a content in the end product of from 3 to 90% by weight. The impact modified heterophasic polypropylene has a multiphase structure with a homopolymer matrix and inclusions consisting of amorphous EP-copolymer (i.e., rubber) and crystalline polyethylene.

The morphology of the graft copolymer is such that the propylene polymer material is the continuous or matrix phase, and the polymerized monomers, both grafted and ungrafted, are present in a dispersed phase.

Preparation of graft copolymers by contacting a propylene polymer with a free radical polymerization initiator, such as an organic peroxide, and a monomer is described in more detail in U.S. Pat. No. 5,140,074, which is incorporated herein by reference in its entirety.

In still other embodiments, the present disclosure provides a compatibilizer or coupling agent made from a masterbatch composition comprising from greater than 50 to about 99 wt. % (based on total weight of the masterbatch composition) of a polypropylene grafted with a monomer containing acid or anhydride functional groups, and from 1 to less than 50 wt. % (based on total weight of the masterbatch composition) of a polypropylene obtained by using a metallocene catalyst.

In still other embodiments, the present disclosure provides a compatibilizer or coupling agent made from a masterbatch composition comprising from 1 to 99 wt. % (based on total weight of the masterbatch composition) of a polypropylene grafted with a monomer containing maleic anhydride functional groups and from 1 to 99 wt. % (based on total weight of the masterbatch composition) of a polypropylene obtained by using a metallocene catalyst having Melt Flow Rate (230° C./2.16 kg) (“MFR”) higher than 100 g/10 min.

For example, a polypropylene grafted with maleic anhydride and a metallocene base resin can be used as a coupling agent for fillers, such as glass fibers, talc, mica, nanoclays, fire retardants, foaming agents and the like, and the mixtures thereof.

In another embodiment, a polypropylene grafted with maleic anhydride and a metallocene base resin can be used as a compatibilizer in alloys of dissimilar polymers, such as in blends of polyolefins with polyamides.

The polypropylene can be a homo- or co-polymer of propylene, with particularly preferred embodiments being the homopolymer. Among co-polymers particularly preferred copolymers are impact modified heterophasic propylene copolymers.

Polypropylenes prepared over a metallocene catalyst are known in the art as “metallocene polypropylenes” or “metallocene propylene (co)polymers.” Examples of such metallocene polypropylenes are those commercially available by LyondellBasell under the tradename “Metocene”. See, U.S. Pat. No. 6,747,077, which is incorporated herein by reference in its entirety. As with the impact modified propylenes, homopolymers or copolymers of propylene can be polymerized by metallocene catalysts. Particularly preferred polymers are polypropylene, which may be a propylene homopolymer or a propylene copolymer having up to 30% by weight of other olefins up to 10 carbon atoms in copolymerized form. Such other olefins are in particular C₂ to C₁₀-1-alkenes, such as ethylene, 1-butene, 1-pentene, 1-hexene, 1-heptene or 1-octene, with preference for ethylene, 1-butene or ethylene and 1-butene. Particular preference is for propylene homopolymers polymerized by metallocene catalysts. Metallocene based polypropylenes for use in the masterbatch compositions have values of MFR of at least 100 g/10 min., preferably of at least 450 g/10 min., more preferably of at least 500 g/10 min, measured at 230° C./2.16 kg. For example, the second polypropylene composition has a MFR between 100 g/10 min and 500 g/10 min measured at 230° C./2.16 kg according to ASTM D 1238. The second polypropylene composition may have a MFR between 100 g/10 min and 400 g/10 min measured at 230° C./2.16 kg according to ASTM D 1238. The second polypropylene composition may have a MFR between 100 g/10 min and 300 g/10 min measured at 230° C./2.16 kg according to ASTM D 1238. The second polypropylene composition may have a MFR between 100 g/10 min and 200 g/10 min measured at 230° C./2.16 kg according to ASTM D 1238. The second polypropylene composition may have a MFR between 200 g/10 min and 500 g/10 min measured at 230° C./2.16 kg according to ASTM D 1238. The second polypropylene composition may have a MFR between 300 g/10 min and 500 g/10 min measured at 230° C./2.16 kg according to ASTM D 1238. The second polypropylene composition may have a MFR between 400 g/10 min and 500 g/10 min measured at 230° C./2.16 kg according to ASTM D 1238.

When the second polypropylene composition comprises more than one polypropylene, at least one polypropylene has a MFR of at least 500 g/10 min measured at 230° C./2.16 kg according to ASTM D 1238. In a generic example, the second polypropylene composition further comprises a primary polypropylene and at least one secondary polypropylene. When the second polypropylene composition comprises a primary polypropylene and at least one secondary polypropylene, the primary polypropylene has a MFR between 100 and 800 g/10 min measured at 230° C./2.16 kg according to ASTM D 1238, and the secondary polypropylene has a MFR between 2 and 100 g/10 min measured at 230° C./2.16 kg according to ASTM D 1238. In some examples, the primary polypropylene has a MFR between 300 and 800 g/10 min measured at 230° C./2.16 kg according to ASTM D 1238, and the secondary polypropylene has a MFR between 2 and 100 g/10 min measured at 230° C./2.16 kg according to ASTM D 1238. The primary polypropylene may have a MFR between 400 and 800 g/10 min measured at 230° C./2.16 kg according to ASTM D 1238, and the secondary polypropylene may have a MFR between 2 and 100 g/10 min measured at 230° C./2.16 kg according to ASTM D 1238. The primary polypropylene may have a MFR between 500 and 800 g/10 min measured at 230° C./2.16 kg according to ASTM D 1238, and the secondary polypropylene may have a MFR between 2 and 100 g/10 min measured at 230° C./2.16 kg according to ASTM D 1238. The primary polypropylene may have a MFR between 500 and 600 g/10 min measured at 230° C./2.16 kg according to ASTM D 1238, and the secondary polypropylene may have a MFR between 2 and 100 g/10 min measured at 230° C./2.16 kg according to ASTM D 1238. In specific examples, the primary polypropylene may have a MFR of 500 g/10 min measured at 230° C./2.16 kg according to ASTM D 1238, and the secondary polypropylene may have a MFR between 2 and 100 g/10 min measured at 230° C./2.16 kg according to ASTM D 1238.

The term “ASTM D 1238” as used herein refers to the standard test method for determining melt flow rates of thermoplastics by extrusion plastometer. In general, this test method covers the determination of the rate of extrusion of molten thermoplastic resins using an extrusion plastometer. After a specified preheating time, resin is extruded through a die with a specified length and orifice diameter under prescribed conditions of temperature, load, and piston position in the barrel. This test method was approved on Feb. 1, 2012 and published March 2012, the contents of which are incorporated herein by reference in its entirety. For the referenced ASTM standards, visit the ASTM website, www.astm.org, or contact ASTM Customer Service at service@astm.org.

The first polypropylene may be an impact or heterophasic polypropylene copolymer. In general, an impact or heterophasic polypropylene copolymer is made of propylene derived units; or, propylene derived units copolymerized with ethylene derived units. In preferred embodiments, the impact or heterophasic polymers has a polymer matrix comprising 80 to 92 wt. % propylene derived units and 8 to 20% wt. % ethylene derived units; or, a polymer matrix comprising 10 wt % to 40 wt % of an ethylene/propylene copolymer (EPR or rubber phase) with ethylene present in 8 wt % to 20 wt % with the remainder being a propylene, ethylene or 1-butene derived polymer.

The second polypropylene may be a homopolymer. The second polypropylene is a metallocene polymerized homopolymer with narrow molecular weight distribution (PI<2), melting point Tm in the range of 152 C-155 C and melt flow rate MFR>100 g/10 minutes (ASTM 1276 21.6 kg at 230 C).

The third polypropylene is obtained by using a Ziegler-Natta catalyst. The third polypropylene is obtained by using a Ziegler-Natta catalyst and may be a reactor grade or controlled rheology polypropylene with MFR 1-50 g/10 minutes and molecular weight distribution (PI=2.5-5.5).

The polymer compositions and/or the masterbatch compositions as described herein may include one or more additives and/or auxiliaries. Exemplary additives and/or auxiliaries include, but are not limited to: (1) stabilizers against damaging processing effects; (2) antioxidants against heat oxidation and aging, UV action; (3) neutralizing agents; (4) fillers; (5) organic and inorganic pigments or pigment preparations, such as carbon black dispersions in polyolefins; (6) antistatic agents; (7) nonpolar waxes or low molecular weight glidants; and, (8) lubricants. Other additives and auxiliaries are well known in the art.

The masterbatch composition, the third polypropylene and the filler may be compounded in traditional polymer processing apparatus, such as a twin screw extruder to mix the filler, such as cut glass fibers, with the polymer coupling agent. Examples of the filler include, but are not limited to, continuous glass fiber, filaments, woven or non-woven cloth, batts, mats, fibrils, tows and other forms. In specific examples, the filler is cut glass fibers.

Polypropylene synthesized using a metallocene catalyst can be made in accordance with methods that are standard in the art. See, e.g., Y. V. Kissin, Alkene Polymerization Reactions with Transition Metal Catalysts (Elsevier) (2008); Ray Hoff and Robert T. Mathers, Handbook of Transition Metal Polymerization Catalysts (John Wiley & Sons) (2010); E. P. Moore, Polypropylene Handbook. Polymerization, Characterization, Properties, Processing, Applications (Hanser Publishers: New York) (1996); G. M. Benedikt, and B. L. Goodall, eds., Metallocene Catalyzed Polymers (ChemTech Publishing: Toronto) (1998), the contents of which are incorporated herein by reference in its entirety.

The structural and physical characteristics of polypropylene depend greatly on the type of catalyst used in the polymerization of the propylene monomer. The most common catalysts used in the polymerization are the Zigler-Natta and metallocene types. The heterogeneous Ziegler-Natta catalyst was developed in the early 1950s. In general, the polymerization of polypropylene using the metallocene type catalyst includes the combination of stereorigid metallocenes of transition metals combined with methylaluminoxane (MAO). In general, the metallocene type catalyst creates a single active metal site which increases the ability to control the molecular weight distribution when compared with Ziegler-Natta catalysts which have multiple metal sites and provide little control for molecular weight distribution. Also, metallocene derived polypropylene displays a narrow molecular weight and narrow defect distributions while Ziegler-Natta catalysts yields a polypropylene with broad molecular weight distributions and broad defect distributions.

The differences between polypropylene derived from a metallocene catalyst and a Ziegler-Natta catalyst have been extensively investigated. See, e.g., Y. V. Kissin, Alkene Polymerization Reactions with Transition Metal Catalysts (Elsevier) (2008); Ray Hoff and Robert T. Mathers, Handbook of Transition Metal Polymerization Catalysts (John Wiley & Sons) (2010); E. P. Moore, Polypropylene Handbook. Polymerization, Characterization, Properties, Processing, Applications (Hanser Publishers: New York) (1996); G. M. Benedikt, and B. L. Goodall, eds., Metallocene Catalyzed Polymers (ChemTech Publishing: Toronto) (1998).

The differences found in polypropylenes derived from metallocene catalysts and Ziegler-Natta catalyst can be explained by examining the mechanism of the polypropylene polymerization process. During the polymerization process, addition of propylene units at the chain end in a head-to-tail manner and in the same stereo arrangement results in the formation of isotactic polypropylene. Any change of insertion mode, i.e., head-to-head or tail-to-tail, or stereo-irregularities is termed a defect. If a propylene unit is added to the chain in a head-to-head or tail-to-tail manner, then a regio defect is formed. When propylene units add to a growing polymer chain with all the methyl groups located on the same side of the chain, then isotactic polypropylene is formed. If the methyl groups alternate from one side of the polymer chain to the other, syndiotactic polypropylene is formed.

Isotactic polypropylene can crystalize to form different crystal modifications (α, β, γ and smectic). The α-form is considered to be the preferred modification formed during crystallization of isotactic polypropylene prepared with conventional catalyst systems, although calculations indicate that the γ-form is more stable. With metallocene catalysis, it became possible to produce high molecular weight isotactic polypropylene which can crystallize to form the γ-form exclusively. There is a linear correlation between the content of the γ-form and the average isotactic segment length between two steric irregularities such as 2,1- and 1,3-insertion or isolated stereoirregular insertion, as reflected by the mrrm pentads in the 13C NMR spectrum. The average segment length also controls the melting temperature of the polypropylene, which can be varied between 120 and 165° C. Since the γ-form does not form spherulites, the corresponding polypropylene exhibits much improved optical clarity with respect to that of conventional isotactic polypropylene.

Additional differences between a metallocene derived polypropylene and a Zeigler-Natta derived polypropylene include differences between the amount of extractables present in the polypropylene. The proportion of extractables is 2 to 5 wt. % for Zeigler-Natta derived polypropylene, while it is only about 0.1% for metallocene derived polypropylene. Therefore, the hardness of metallocene derived polypropylene is higher than that of Zeigler-Natta derived polypropylene. One of the primary differences is found in the molecular weight distribution as pointed out above with metallocene derived polymers having a molecular weight distribution less than 2.

It was unexpectedly found that the use of the metallocene as a second polypropylene significantly improves the performance of the masterbatch in compatibilizer and coupling agent applications. It could be the combined characteristics of the mPP helps the bonding between the polar and non-polar moieties and also improves the physical properties of the composite.

When the masterbatch compositions as described herein are used as a coupling agent for dissimilar resins, the resulting composition may be blended, co-extruded, coated on one or both of the dissimilar resins in the form of pellets or used in the form of a separate layer or coating to improve the compatibility of the dissimilar resins with each other. Polyamides, which are defined a monomers of amide joined by peptide bonds, can be used. Polyamides can occur naturally or artificially, examples being proteins, such as wool and silk, and can be made through step-growth polymerization or solid-phase synthesis, examples being nylons and aramids. Examples of commercially available artificial polyamides are Nylon 6, Nylon 66, and copolymers, such as polyamide 6/66, polyamide 66/610.

Articles formed from the disclosed compositions can be made by molding. Conventional forms of molding, including injection molding, casting, extrusion, compression molding, transfer molding, forging, and injection-blow molding are suitable methods for forming the composite articles.

### Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

The terms “ISO 527-1” and “ASTM D 638” as used herein refer to the standard test method for determining the tensile properties of unreinforced and reinforced plastics in the form of standard dumbbell-shaped test specimens when tested under defined conditions of pretreatment, temperature, humidity, and testing machine speed. The ASTM D 638 test method and the ISO 527-1 test method are technically equivalent. This test method is designed to produce tensile property data for the control and specification of plastic materials. Tensile properties may vary with specimen preparation and with speed and environment of testing. Consequently, where precise comparative results are desired, these factors must be carefully controlled. It is realized that a material cannot be tested without also testing the method of preparation of that material. Hence, when comparative tests of materials per se are desired, the greatest care must be exercised to ensure that all samples are prepared in exactly the same way, unless the test is to include the effects of sample preparation. Similarly, for referee purposes or comparisons within any given series of specimens, care must be taken to secure the maximum degree of uniformity in details of preparation, treatment, and handling. This test method was approved on May 15, 2010 and published June 2010, the contents of which are incorporated herein by reference in its entirety. For the referenced ASTM standards, visit the ASTM website, www.astm.org, or contact ASTM Customer Service at service@astm.org.

The term “ISO 527-2” as used herein refers to the standard test method for testing the tensile properties by elongating a specimen and measuring the load carried by the specimen. From the knowledge of the specimen dimensions, the load and deflection data can be translated into a stress-strain curve. A variety of tensile properties can be extracted from the stress-strain curve. For example, the term “tensile strain at break” as used herein refers to the tensile strain corresponding to the point of rupture. The term “nominal tensile strain at break” as used herein refers to the tensile strain at the tensile stress at break. The term “tensile strain at yield” as used herein refers to the tensile strain corresponding to the yield (an increase in strain does not result in an increase in stress). The term “tensile stress at break” as used herein refers to the tensile stress corresponding to the point of rupture. The term “tensile stress at 50% strain” as used herein refers to the tensile stress recorded at 50% strain. The term “tensile modulus” as used herein is often referred to as the Young's modulus, or the modulus of elasticity. The tensile modulus is the slope of the secant line between 0.05% and 0.25% strain on a stress-strain plot. The tensile modulus is calculated using the formula:

Et=(σ2−σ1)/(ε2−ε1)

where ε1 is a strain of 0.0005, ε2 is a strain of 0.0025, σ1 is the stress at ε1, and σ2 is the stress at ε2.

The term “ISO 178” as used herein refers to the standard test method for testing the flexural properties of a material. In particular, the flexural test measures the force required to bend a beam under three point loading conditions. The data is often used to select materials for parts that will support loads without flexing. Flexural modulus is used as an indication of a material's stiffness when flexed. Since the physical properties of many materials (especially thermoplastics) can vary depending on ambient temperature, it is sometimes appropriate to test materials at temperatures that simulate the intended end use environment. Most commonly the specimen lies on a support span and the load is applied to the center by the loading nose producing three point bending at a specified rate. The parameters for this test are the support span, the speed of the loading, and the maximum deflection for the test. These parameters are based on the test specimen thickness and are defined differently by ASTM and ISO standards. For ASTM D790, the test is stopped when the specimen reaches 5% deflection or the specimen breaks before 5%. For ISO 178, the test is stopped when the specimen breaks. Of the specimen does not break, the test is continued as far as possible and the stress at 3.5% (conventional deflection) is reported. A variety of specimen shapes can be used for this test, but the most commonly used specimen size for ASTM is 3.2 mm×12.7 mm×125 mm (0.125″×0.5″×5.0″) and for ISO is 10 mm×4 mm×80 mm. By using the flexural text, the following data may be obtained: flexural stress at yield, flexural strain at yield, flexural stress at break, flexural strain at break, flexural stress at 3.5% (ISO) or 5.0% (ASTM) deflection, and flexural modulus.

The terms “ISO 179/1eU” and “ISO 179/1eA” as used herein refer to the “Charpy test” or the standard test method for investigating the effects of the change in the formulation, compounding or injection molding conditions on the test specimen. In particular, the Charpy ISO 179/1eA protocol is used to evaluate an edgewise notched specimen and the ISO179/1eU protocol is used to evaluate an edgewise un-notched specimen.

The term “ISO 306” as used herein refers to an international standard test provides a method for the determining the Vicat softening temperature (VST) for thermoplastic materials. In general, the Vicat softening temperature is the measure of the temperature at which a standard indenting tip with a flat point penetrates a depth of 1 mm into the surface of a plastic test specimen. The indenting tip exerts a specified force perpendicular to the test specimen, while the specimen is heated at a specified and uniform rate. The temperature, in degree Celsius, of the specimen, measured as close as possible to the indented area at 1 mm penetration, is quoted as the VST.

The masterbatch compositions shown in Table 1 were prepared by compounding the formulations in an 18 mm Leistritz twin screw extruder at a temperature of 450° F. at a rate of 20 lb/hr and a RPM of 250. The masterbatch composition of Example 1 comprises 50 wt % of a polypropylene grafted with maleic anhydride, 49.85 wt % of a metallocene derived polypropylene homopolymer (Metocene MF650W), 0.075 wt % of a primary antioxidant and 0.075 wt % of a secondary antioxidant. The masterbatch composition of Example 2 comprises 60 wt % of a polypropylene grafted with maleic anhydride, 39.85 wt % of a metallocene derived polypropylene homopolymer (Metocene MF650W), 0.075 wt % of a primary antioxidant and 0.075 wt % of a secondary antioxidant. The masterbatch composition of Example 3 comprises 50 wt % of a polypropylene grafted with maleic anhydride, 24.925 wt % of a metallocene derived polypropylene homopolymer (Metocene MF650W), 29.925 wt % of a Zeigler-Natta (ZN) based propylene polymer having a melt flow rate of 65 g/10 min, 0.075 wt % of a primary antioxidant and 0.075 wt % of a secondary antioxidant. The masterbatch composition of Example 4 comprises 60 wt % of a polypropylene grafted with maleic anhydride, 19.925 wt % of a metallocene derived polypropylene homopolymer (Metocene MF650W), 19.925 wt % of a Zeigler-Natta (ZN) based propylene polymer having a melt flow rate of 65 g/10 min, 0.075 wt % of a primary antioxidant and 0.075 wt % of a secondary antioxidant (A/O). The masterbatch of Example 5 is used as a comparative example to demonstrate various differences between Example 5 which contains no metallocene derived polypropylene and the masterbatch compositions of Examples 1-4 which contain a metallocene derived polypropylene.

TABLE 1
Masterbatch Compositions

| | First Polymer | Second Polymer Composition | | | | | |
|---|---|---|---|---|---|---|---|
| | Composition - | Metocene | Adstif | Petrothene | Primary | Secondary | Maleic |
| | PP Graft | MF650W | HA801U | PP31KK01 | antioxidant | antioxidant | Anhydride |
| Ex. | (wt %) | (wt %) | (wt %) | (wt %) | (wt %) | (wt %) | (wt %) |
| 1 | 50 | 49.85 | — | — | 0.075 | 0.075 | 1 |
| 2 | 60 | 39.85 | — | — | 0.075 | 0.075 | 1.25 |
| 3 | 50 | 24.925 | 24.925 | — | 0.075 | 0.075 | 1 |
| 4 | 60 | 19.925 | 19.925 | — | 0.075 | 0.075 | 1.25 |
| 5 | 50 | — | — | 49.85 | 0.075 | 0.075 | 1 |

The wt % values reflected in Table 1 are based on the total weight of the masterbatch composition. The grafted polypropylene (PP graft) is a Zeigler-Natta (ZN) heterophasic propylene copolymer with a melt flow rate of 1.8 g/10 min and density of 0.90 g/cm3 grafted with 2 wt % (based on the total weight of the grafted polypropylene) maleic anhydride. Metocene MF650 W is a metallocene propylene homopolymer commercially available from LyondellBasell with MFR of 500 g/10 min and density of 0.91 g/cm3. Adstif HA801U is a ZN propylene homopolymer commercially available from LyondellBasell with melt flow rate of 65 g/10 min. Petrothene PP31KK01 is a ZN propylene homopolymer commercially available from LyondellBasell with melt flow rate of 5 g/10 min.

Using the masterbatch compositions of Examples 1-5, the polymer compositions (Examples 6-10 as shown in Table 2) were prepared by compounding the formulations in an 18 mm Leistritz twin screw extruder at a temperature of 450° F. at a rate of 20 lb/hr and a RPM of 250.

TABLE 2
Polymer Compositions

| | Third | Filler | Masterbatch Composition | | | | | | |
|---|---|---|---|---|---|---|---|---|---|
| | Polypropylene | Chopped glass | | | | | Masterbatch | Other Additives | |
| | Moplen MP | fibers of | Masterbatch | Masterbatch | Masterbatch | Masterbatch | of Ex. 5 | | Colorant |
| | 2000HEXP | from 2-4 mm | of Ex. 1 | of Ex. 2 | of Ex. 3 | of Ex. 4 | (comparative) | Antioxidants | (Pigments) |
| Ex. | (wt %) | (wt %) | (wt %) | (wt %) | (wt %) | (wt %) | (wt %) | (wt %) | (wt %) |
| 6 | 53.40 | 40.00 | 2.50 | — | — | — | — | 1.0 | 3.10 |
| 7 | 53.40 | 40.00 | — | 2.50 | — | — | — | 1.0 | 3.10 |
| 8 | 53.40 | 40.00 | — | — | 2.50 | — | — | 1.0 | 3.10 |
| 9 | 53.40 | 40.00 | — | — | — | 2.50 | — | 1.0 | 3.10 |
| 10 | 53.40 | 40.00 | — | — | — | — | 2.50 | 1.0 | 3.10 |

The wt % values reflected in this table are based on the total weight of the polymer composition. Moplen MP 2000 HEXP is a heterophasic propylene copolymer commercially available from LyondellBasell. Example 10 is a Comparative Example.

The tensile properties of the polymers resulting from the polymer compositions of Examples 6-10 are shown in Table 3. The tensile properties were measured according to method ISO 527-1 and ISO 527-2 at 23° C.

TABLE 3
Tensile Properties

| | Tensile | Tensile | Tensile | Tensile | |
|---|---|---|---|---|---|
| | stress | strain | stress | strain | Tensile |
| | at yield | at yield | at break | at break | modulus |
| | (σ_{y}) | (ε_{y}) | (σ_{B}) | (ε_{B}) | (Eₜ) |
| Ex. | MPa | (%) | MPa | (%) | MPa |
| 6 | 75.1 | 3.2 | 72.5 | 4.2 | 7710 |
| 7 | 73.4 | 3.4 | 71 | 4.4 | 7670 |
| 8 | 74.4 | 3.3 | 72.3 | 4.3 | 7690 |
| 9 | 74.2 | 3.2 | 71.3 | 4.3 | 7660 |
| 10 | 71.1 | 3.2 | 68.4 | 4.3 | 7090 |

The flexural properties of the polymers resulting from the polymer compositions of Examples 6-10 are shown in Table 4. The flexural properties were measured according to method ISO178 at 23° C.

TABLE 4
Flexural Properties

| | | Strain at | | | Flexural | Flexural | |
|---|---|---|---|---|---|---|---|
| | Flexural | flexural | Flexural | Flexural | stress at | strain at | Flexural |
| Ex. | Strength | strength | stress at S_{c} | strain S_{c} | break | break | modulus |
| 6 | 101.1 | 3.4 | 101 | 3.3 | 97.9 | 4.1 | 8020 |
| 7 | 101.5 | 3.5 | 101.4 | 3.3 | 98.2 | 4.1 | 8030 |
| 8 | 100.8 | 3.5 | 100.7 | 3.3 | 97.6 | 4.1 | 7930 |
| 9 | 101.7 | 3.5 | 101.5 | 3.3 | 98.3 | 4.1 | 7950 |
| 10 | 93.3 | 3.8 | 92.7 | 3.3 | 90 | 4.7 | 6890 |

The term “S_{c}” represents nominal bending.

Additional properties of the polymers resulting from the polymer compositions of Examples 6-10 are shown in Table 5. Table 5 provides a comparison between the charpy unnotched impact strength and the charpy notched impact strength. The charpy unnotched impact strength was measured according to method ISO179/1eU at 23° C., 0° C. and −30° C. The charpy notched impact strength was measured according to ISO179/1eA at 23° C., 0° C. and −30° C. The vicat softening temperature was measured according to ISO 306.

TABLE 5
Impact Strength

| | Charpy Unnotched | | | Charpy Notched | | | Vicat softening |
|---|---|---|---|---|---|---|---|
| | Impact Strength | | | Impact Strength | | | temperature |
| | (kJ/m²) | | | (kJ/m²) | | | (° C.) |
| | 23° | 0° | −30° | 23° | 0° | −30° | B50 (50° C./ |
| Ex. | C. | C. | C. | C. | C. | C. | h, 50N) |
| 6 | 53.7 | 55.9 | 53.5 | 16.7 | 13.3 | 10.6 | 88 |
| 7 | 48.4 | 52.6 | 55.5 | 17 | 13.8 | 10 | 86.2 |
| 8 | 51.9 | 52.1 | 56.7 | 16.7 | 13.8 | 10.4 | 85.4 |
| 9 | 50.9 | 53.6 | 55.3 | 16.6 | 13.5 | 10.2 | 85.4 |
| 10 | 46.3 | 49.7 | 51.6 | 15.6 | 11.3 | 9 | 88.9 |

It will be appreciated from a review of the results shown in Table 3, Table 4 and Table 5 that the compositions as disclosed herein have superior mechanical properties, making them more suitable for use in the preparation of molded articles, using methods such as injection molding and compression molding.

The masterbatch compositions shown in Table 6 were prepared by compounding the formulations in an 18 mm Leistritz twin screw extruder at a temperature of 450° F. at a rate of 20 lb/hr and a RPM of 250.

TABLE 6
Masterbatch Compositions

| | First | Second | | | |
|---|---|---|---|---|---|
| | Polymer | Polymer | | | |
| | composition - | Composition - | Irganox | Irgafos | |
| | PP Graft | Polypropylene* | 1010 | 168 | Total |
| Ex. | (wt. %) | (wt. %) | (wt. %) | (wt. %) | Weight |
| 11 | 30 | 69.85 | 0.075 | 0.075 | 100 |
| (Compar- | | | | | |
| ative) | | | | | |
| 12 | 70 | 29.85 | 0.075 | 0.075 | 100 |
| 13 | 40 | 59.85 | 0.075 | 0.075 | 100 |
| (Compar- | | | | | |
| ative) | | | | | |
| 14 | 60 | 39.85 | 0.075 | 0.075 | 100 |

*This polypropylene is derived from a metallocene.

Using the masterbatch compositions of Examples 11-14, the polymer compositions (Examples 15-18 as shown in Table 7) were prepared by combining an impact polypropylene, a glass filler and an additive. These polymer compositions were compounded in a 27 mm Leistritz twin screw extruder at a temperature of 450° F., at a rate of 100 lb./hr. and RPM of 55 to produce the glass filled polypropylene composites as shown in Table 7.

Glass Filled Polypropylene Composite Formulations
2.5 wt. % Masterbatch (Examples 11, 12, 13 and 14)
65 wt. % impact polypropylene (Profax 7523 (4.00 MFR at 230° C./2.16 kg))
30 wt. % Short Glass
2.5 wt. % B225 A/O

TABLE 7
Glass Filled Polypropylene Compositions

| | Third | Filler | | | | | |
|---|---|---|---|---|---|---|---|
| | Polypropylene | Chopped glass | Masterbatch Composition | | | | |
| | Impact | fibers of | Masterbatch | Masterbatch | Masterbatch | Masterbatch | Other Additives |
| | Polypropylene* | from 2-4 mm | of Ex. 11 | of Ex. 12 | of Ex. 13 | of Ex. 14 | Antioxidants** |
| Ex. | (wt %) | (wt %) | (wt %) | (wt %) | (wt %) | (wt %) | (wt %) |
| 15 | 65 | 30.00 | 2.50 | — | — | — | 2.5 |
| 16 | 65 | 30.00 | — | 2.50 | — | — | 2.5 |
| 17 | 65 | 30.00 | — | — | 2.50 | — | 2.5 |
| 18 | 65 | 30.00 | — | — | — | 2.50 | 2.5 |

The wt % values reflected in this table are based on the total weight of the polymer composition.
*The impact polypropylene is Profax 7523 which has a MFR of 4.00 measured at 230° C./2.16 kg.
**The Antioxidant used in these examples is Irganox B225 which is 50% Irgafos 168 and 50% Irganox 1010

The tensile properties of the polymers resulting from the polymer compositions of Examples 15-18 are shown in Table 8. The tensile properties were measured according to method ISO527-12 at 23° C. Table 8 also shows the flexural properties of the polymers resulting from the polymer compositions of Examples 15-18. The flexural properties were measured according to method ISO178 at 23° C. In addition to the tensile properties and the flexural properties, Table 8 also shows the impact properties which were measured according to ISO 180 at 23° C.

TABLE 8
Physical Properties

| | | | | Tensile stress | Tensile stress | |
|---|---|---|---|---|---|---|
| | Melt | Izod | Flexural | at break | at yield | Tensile modulus |
| Ex. | Index | Impact | modulus | (σ_{B}) MPa | (σ_{y}) MPa | (Eₜ) MPa |
| 15 | 2.7 | 16.7 | 5064 | 70.4 | 71.34 | 6087 |
| 16 | 2.1 | 17.6 | 5689 | 74.8 | 75.3 | 6834 |
| 17 | 2.7 | 16.6 | 4449 | 64.9 | 65.9 | 5326 |
| 18 | 2.3 | 17.3 | 5091 | 69.4 | 70.1 | 6082 |

It will be appreciated that when the Ziegler Natta grafted polypropylene is greater in proportion than the metallocene polypropylene in the masterbatch composition, the resulting masterbatch has superior properties than masterbatch compositions wherein the metallocene polypropylene is greater in proportion than the Ziegler Natta grafted polypropylene.

The masterbatch compositions shown in Table 9 were prepared by compounding the formulations in an 18 mm Leistritz twin screw extruder at a temperature of 450° F. at a rate of 20 lb/hr and a RPM of 250.

TABLE 9
Masterbatch Compositions

| | First Polymer | Second Polymer | Second Polymer | | | |
|---|---|---|---|---|---|---|
| | composition - | Composition - | Composition - | Irganox | Irgafos | |
| | PP Graft | Polypropylene* | Polypropylene** | 1010 | 168 | Total |
| Ex. | (wt. %) | (wt. %) | (wt. %) | (wt. %) | (wt. %) | Weight |
| 14 | 60 | 39.85 | — | 0.075 | 0.075 | 100 |
| 19 | 60 | — | 39.85 | 0.075 | 0.075 | 100 |

*This polypropylene is derived from a metallocene and has a MFR of 500.
**This polypropylene is derived from a metallocene and has a MFR of 60.

Using the masterbatch compositions of Examples 14 and 19, the polymer compositions (Examples 18 and 20 as shown in Table 10) were prepared by combining an impact polypropylene, a glass filler and an additive. These polymer compositions were compounded in a 27 mm Leistritz twin screw extruder at a temperature of 450° F., at a rate of 100 lb./hr. and RPM of 55 to produce the glass filled polypropylene composites as shown in Table 10.

TABLE 10
Physical Properties

| | | | | Tensile stress | Tensile stress | |
|---|---|---|---|---|---|---|
| | Melt | Izod | Flexural | at break | at yield | Tensile modulus |
| Ex. | Index | Impact | modulus | (σ_{B}) MPa | (σ_{y}) MPa | (Eₜ) MPa |
| 18 | 2.3 | 17.3 | 5091 | 69.4 | 70.1 | 6082 |
| 20 | 2.21 | 16.1 | 4088 | 63.3 | 64.0 | 5104 |

It will be appreciated from Table 10 that when a higher melt flow rate metallocene polypropylene is used in the masterbatch compositions, the resulting masterbatch has superior properties than masterbatch compositions wherein the metallocene polypropylene has a lower melt flow rate. Example 20 is a comparative example.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of the ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A polymer composition comprising:
(A) from 0.1 to 10.0 wt. %, based on the total weight of the polymer composition, of a masterbatch composition comprising:
(i) from 1 to 99 wt. %, based on the total weight of the masterbatch composition, of a first polypropylene composition, wherein the first polypropylene composition comprises a polypropylene grafted with a monomer containing acid or anhydride functional groups, and
(ii) from 1 to 99 wt. %, based on the total weight of the masterbatch composition, of a second polypropylene obtained by using a metallocene catalyst,
(B) from 50 to 90 wt %, based on the total weight of the polymer composition, of a third polypropylene, and
(C) from 5 to 45 wt %, based on the total weight of the polymer composition, of a filler.

2. The polymer composition of claim 1 wherein the acid or anhydride functional group is maleic anhydride.

3. The polymer composition of claim 2 wherein the maleic anhydride is present in 0.5 to 5 wt. %, based on the total weight of the grafted polypropylene.

4. The polymer composition of claim 1 wherein the filler is short glass fibers, talc, mica, nanoclays, fire retardants, and foaming agents, or mixtures thereof.

5. The polymer composition of claim 1 wherein the first polypropylene is an impact modified heterophasic polypropylene copolymer.

6. The polymer composition of claim 1 wherein the second polypropylene is a homopolymer.

7. The polymer composition of claim 1 wherein the third polypropylene is obtained by using a Ziegler-Natta catalyst.

8. The polymer composition of claim 1 wherein the second polypropylene has a Melt Flow Rate (230° C./2.16 kg) of at least 100 g/10 min.

9. The polymer composition of claim 8 wherein the second polypropylene has a Melt Flow Rate (230° C./2.16 kg) of at least 450 g/10 min.

10. The polymer composition of claim 1 further comprising an additive.

11. The polymer composition of claim 10 wherein the additive is a stabilizer, antioxidant, neutralizing agent, organic or inorganic pigment, antistatic agent, nonpolar wax, or low molecular weight glidant, low molecular weight lubricant, or mixtures thereof.

12. A masterbatch composition comprising:
(a) from 50 to 99% wt of a first polypropylene composition, wherein the first polypropylene composition comprises a polypropylene grafted with a monomer containing acid or anhydride functional groups, and
(b) from 1 to 50% wt of a second polypropylene obtained by using a metallocene catalyst.

13. The masterbatch composition of claim 12 wherein the maleic anhydride is 0.5-5% wt of the grafted polypropylene.

14. The masterbatch composition of claim 13 wherein the first polypropylene is an impact heterophasic polypropylene copolymer.

15. The polymer composition of claim 14 wherein the second polypropylene is a homopolymer.

16. A masterbatch composition comprising:
(a) from 1 to 99% of a first polypropylene composition wherein the first polypropylene comprises a polypropylene grafted with a monomer containing maleic anhydride functional groups and
(b) from 1 to 99% of a second polypropylene obtained by using a metallocene catalyst having Melt Flow Rate (230° C./2.16 kg) higher than 100 g/10 min.

17. The masterbatch composition of claim 16 wherein the first polypropylene is an impact heterophasic polypropylene copolymer.
The polymer composition of claim 16 wherein the second polypropylene is a homopolymer.

18. The polymer composition of claim 16 wherein the second polypropylene is a homopolymer.
